(19) United States
(12) Patent Application Publication
(10) Pub. No.: US 2016/0088856 A1
(43) Pub. Date: Mar. 31, 2016

(54) BAKED FAT-BASED CONFECTIONERY AND METHOD FOR MANUFACTURING SAME

(71) Applicant: MEIJI CO., LTD., Tokyo (JP)

(72) Inventors: Noriyuki HIROTA, Tsurugashima-shi, Saitama (JP); Tadashi MATSUURA, Takatsuki-shi, Osaka (JP)

(73) Assignee: MEIJI CO., LTD., Tokyo (JP)

(21) Appl. No.: 14/785,191

(22) PCT Filed: Apr. 18, 2014
(86) PCT No.: PCT/JP2014/061082

§ 371 Date: Oct. 16, 2015

(30) Foreign Application Priority Data
Apr. 22, 2013 (JP) 2013-089763

(51) Int. Cl. A23G 1/36; A23G 1/54

(52) U.S. Cl. CPC A23G 1/36; A23G 1/54; A23V 2002/00

(57) ABSTRACT

A baked fat-based confectionery containing a sorbitan fatty acid ester, preferably a sorbitan fatty acid ester with an HLB of 1 to 5. Also disclosed is a method for manufacturing a baked fat-based confectionery, including a step of preparing a fat-based confectionery material containing a sorbitan fatty acid ester, a step of forming the fat-based confectionery material into a prescribed shape to obtain a fat-based confectionery, and a step of baking the fat-based confectionery.

### TECHNICAL FIELD

The present invention relates to a baked fat-based confectionery having good meltability in the mouth without becoming dry and crumbly after baking.

### BACKGROUND ART

Chocolate is mainly made of sugar, cacao mass, milk powder, cocoa butter, etc., and is obtained by pulverizing these raw materials into fine particles and performing solidification by cooling. Chocolate is solid at normal temperature, but when eaten, melts in the mouth due to the heat in the mouth. This is mainly due to the temperature characteristics of the physical properties of cocoa butter.

However, there have been problems that chocolate melts when exposed to a high temperature situation such as summertime; even when melted chocolate is solidified by cooling again as it is, the surface remains sticky because of the state of not being tempered; and what is called bloom occurs during storage and the eating texture and the external appearance are degraded.

In order to solve these problems, a baked fat-based confectionery for which chocolate or the like has been baked for the purpose of providing heat resistance is disclosed (Patent Literature 1).

### CITATION LIST

### Patent Literature

Patent Literature 1: JPs52-148662

### SUMMARY OF INVENTION

### Technical Problem

When chocolate is baked, there are advantages that the surface of the chocolate is hardened to have shape retaining properties even at high temperature and the surface is prevented from sticking to the hand; but on the other hand, there are problems that the eating texture is hard, dry, and crumbly up to the interior, the meltability in the mouth is poor, and the quality is unfavorable as chocolate.

An object of the present invention is to obtain a baked fat-based confectionery in which the surface is hard and has heat resistance, while the interior keeps a state of good meltability in the mouth inherent in chocolate.

### Solution to Problem

The present inventors conducted extensive studies and have obtained, by baking a fat-based confectionery of a specific blend, a novel baked fat-based confectionery in which the surface does not stick to the hand and has heat resistance, and meanwhile the interior keeps a state of good meltability in the mouth. That is, it is as follows:

(1) A baked fat-based confectionery comprising a sorbitan fatty acid ester.
(2) The baked fat-based confectionery according to (1), wherein an HLB of the sorbitan fatty acid ester is 1 or more and 5 or less.
(3) The baked fat-based confectionery according to (2), wherein the sorbitan fatty acid ester is sorbitan monooleate or sorbitan trioleate.
(4) The baked fat-based confectionery according to (1), wherein an HLB of the sorbitan fatty acid ester is 1 or more and 3 or less.
(5) A baked fat-based confectionery obtained by using a fat-based confectionery material, wherein the fat-based confectionery material comprises soy lecithin at 0.9 mass % or more relative to the mass of the whole fat-based confectionery material.
(6) A baked composite fat-based confectionery consisting of a center portion and a shell portion, wherein the center portion consists of a fat-based confectionery comprising a sorbitan fatty acid ester and the shell portion consists of a fat-based confectionery comprising no sorbitan fatty acid ester.
(7) A baked composite fat-based confectionery consisting of a center portion and a shell portion, wherein the center portion consists of a fat-based confectionery obtained by using a fat-based confectionery material comprising soy lecithin at 0.9 mass % or more relative to the mass of the whole fat-based confectionery material of the center portion and the shell portion consists of a fat-based confectionery obtained by using a fat-based confectionery material not comprising soy lecithin at 0.9 mass % or more relative to the mass of the whole fat-based confectionery material of the shell portion.
(8) A method for manufacturing a baked fat-based confectionery, comprising a step of preparing a fat-based confectionery material comprising a sorbitan fatty acid ester, a step of forming the fat-based confectionery material into a prescribed shape to obtain a fat-based confectionery, and a step of baking the fat-based confectionery.
(9) The method for manufacturing a baked fat-based confectionery according to (8), wherein an HLB of the sorbitan fatty acid ester is 1 or more and 5 or less.
(10) The method for manufacturing a baked fat-based confectionery according to (9), wherein the sorbitan fatty acid ester is sorbitan monooleate or sorbitan trioleate.
(11) The method for manufacturing a baked fat-based confectionery according to (8), wherein an HLB of the sorbitan fatty acid ester is 1 or more and 3 or less.
(12) A method for manufacturing a baked fat-based confectionery, comprising a step of preparing a fat-based confectionery material comprising soy lecithin at 0.9 mass % or more relative to the mass of the whole fat-based confectionery material, a step of forming the fat-based confectionery material into a prescribed shape to obtain a fat-based confectionery, and a step of baking the fat-based confectionery.
(13) The method for manufacturing a baked fat-based confectionery according to any one of (8) to (12), wherein the fat-based confectionery material comprises water.

### Advantageous Effects of Invention

According to the present invention, a satisfactory baked fat-based confectionery can be provided in which the surface of the baked fat-based confectionery is hard and has heat resistance, and meanwhile the interior keeps a state of good meltability in the mouth without becoming hard.

### DESCRIPTION OF EMBODIMENTS

Embodiments of the present invention will now be described in detail, but the present invention is not limited to the following embodiments.

A baked fat-based confectionery according to an embodiment of the present invention comprises a sorbitan fatty acid ester.

As the fat-based confectionery in the embodiment, for example, any chocolate such as white chocolate, milk chocolate, or sweet chocolate may be used; and not limited to the chocolate and the quasi chocolate provided in the “Fair Competition Code concerning Labeling on Chocolates”, which is a rule approved by the Fair Trade Commission of Japan, all types of fat-based confectionery that do not come under these, such as fat cream of a tempered type or a non-tempered type, or nut cream may be used.

When a sorbitan fatty acid ester is used in the embodiment, an HLB of the sorbitan fatty acid ester is preferably 1 or more and 5 or less, more preferably 3 or less. This is because the meltability in the mouth of the interior of the baked fat-based confectionery is better.

Examples of the sorbitan fatty acid ester used in the embodiment include sorbitan monolaurate, sorbitan monooleate, and sorbitan trioleate; and it is preferable to use sorbitan monooleate or sorbitan trioleate. In particular, it is preferable to use sorbitan trioleate. This is because the meltability in the mouth of the interior of the baked fat-based confectionery is better.

The content of the sorbitan fatty acid ester used in the embodiment is preferably 0.05 mass % or more and 1 mass % or less, more preferably 0.1 mass % or more and 0.5 mass % or less relative to the mass of the whole fat-based confectionery material for baking. With the content of 0.05 mass % or more, it is easy for the effect of the present invention to be obtained sufficiently. With the content of 1 mass % or less, it is easy for the taste of the emulsifier to avoid affecting the taste of the baked fat-based confectionery.

A baked fat-based confectionery according to another embodiment of the present invention comprises 0.9 mass % or more of soy lecithin relative to the mass of the whole fat-based confectionery material for baking. In the baked fat-based confectionery of the present invention, with soy lecithin contained at 0.9 mass % or more in the fat-based confectionery material, the surface of the obtained baked fat-based confectionery is hard and has heat resistance, while the interior can keep a state of good meltability in the mouth without becoming hard, as in the case where a sorbitan fatty acid ester is used.

The content of soy lecithin is 0.9 mass % or more, preferably 1.2 mass % or more of the whole fat-based confectionery material for baking. The content of the soy lecithin is preferably 3.0 mass % or less, more preferably 2.0 mass % or less of the whole fat-based confectionery. The soy lecithin preferably has an HLB of be 3 to 5. When the baked fat-based confectionery comprises soy lecithin in the range mentioned above, it may comprise a sorbitan fatty acid ester at the same time.

An example of the manufacturing of the baked fat-based confectionery of the embodiment will now be described. First, using cacao mass, sugar, cocoa butter, lecithin, whole milk powder, etc., the processes of raw material mixing, refining, conching, etc. are performed by a conventional method, and a chocolate material that serves as a base is obtained. If necessary, fat and oil, an auxiliary material, etc. may be added to the obtained chocolate material afterward.

When a baked fat-based confectionery comprising a sorbitan fatty acid ester is manufactured, there are no limitations on the method for incorporating the sorbitan fatty acid ester into the chocolate material; for example, it is possible to add the sorbitan fatty acid ester during the mixing of the raw materials of the chocolate material, or it is possible to add the sorbitan fatty acid ester into the obtained chocolate material afterward.

Next, the obtained sorbitan fatty acid ester-comprising chocolate material is formed into a prescribed shape and solidified by cooling, and a chocolate is obtained as a fat-based confectionery for baking. If necessary, tempering may be performed before forming a shape. The tempering may be hand tempering or may be performed using a method involving adding a seeding agent. The method for forming the chocolate into a prescribed shape may be any method. For example, it is possible to inject the chocolate material into a mold and perform solidification by cooling. Alternatively, it is possible to perform forming into a prescribed shape on a flat plate using a depositor or the like and perform solidification by cooling. It is also possible to aerate the chocolate using a mixer and form a shape of the aerated chocolate material by the methods mentioned above or the like.

When a baked fat-based confectionery comprising 0.9 mass % or more of soy lecithin in the fat-based confectionery material for baking is manufactured, a chocolate can be obtained as a fat-based confectionery for baking by a method similar to the method described above except that, in place of the sorbitan fatty acid ester, soy lecithin is incorporated so that its total amount is 0.9 mass % or more. As the method for putting soy lecithin into the chocolate material, it is possible to add a prescribed amount at one time at an ordinary timing at which lecithin is added during the mixing of the raw materials of the chocolate material of the base, or it is possible to perform addition afterward into a chocolate material comprising a small amount of soy lecithin beforehand so that the content of soy lecithin in the chocolate material is 0.9 mass % or more.

In the embodiment, a composite fat-based confectionery that is obtained by coating the surface of the obtained chocolate with a fat-based confectionery such as another chocolate and/or a starch-based raw material and in which two or more confectioneries of different blends and/or compositions are combined may be used as a fat-based confectionery for baking. The baked composite fat-based confectionery according to the embodiment consists of a center portion located in a central portion of the baked composite confectionery and a shell portion located so as to cover part or the whole of the periphery of the center portion. There are no limitations on the method for covering the chocolate for the center portion with a fat-based confectionery and/or a starch-based raw material for the shell portion; for example, it is possible to use a revolving pan to coat the surface of the chocolate with a fat-based confectionery and/or a starch-based raw material, or it is possible to immerse the chocolate in a bath filled with a fat-based confectionery or a material of a starch-based material. In particular, when the chocolate is coated with a fat-based confectionery, it is possible to use a method in which a mold is used to fabricate a shell of a fat-based confectionery and the chocolate material mentioned above is injected into the interior thereof, or it is possible to use what is called the one-shot depositor method.

It is preferable to coat the surface of the chocolate comprising a sorbitan fatty acid ester and/or 0.9 mass % or more of soy lecithin obtained by the method described above with a fat-based confectionery comprising neither a sorbitan fatty acid ester nor 0.9 mass % or more of soy lecithin, particularly with a fat-based confectionery not comprising a sorbitan fatty acid ester with an HLB of 3 or less, and perform baking because the boundary between the shell portion, which has been baked and has a crunchy texture, and the center portion, which keeps meltability in the mouth inherent in chocolate, is clear and the effect is exhibited more.

Next, the obtained chocolate is baked with an oven or the like. It is preferable for the chocolate to be baked at 100° C. or more and 300° C. or less, and it is more preferable to be baked at 160° C. or more and 250° C. or less. Conventionally, if baking is performed at 100° C. or more, the chocolate changes hard and the meltability in the mouth is degraded; but by the manufacturing method of the present invention, the meltability in the mouth of the obtained baked fat-based confectionery is improved, and the effect is exhibited particularly when baking is performed at 100° C. or more.

If possible, after the chocolate material is formed into a prescribed shape, baking may be performed without performing solidification by cooling.

In the embodiment, the fat-based confectionery material may comprise water. There are no particular limitations on the method for incorporating water into the fat-based confectionery material. For example, it is possible to add water during the mixing of the raw materials of the fat-based confectionery material, or it is possible to add water to the obtained fat-based confectionery material afterward. By adding water, the shape retaining properties of the fat-based confectionery material during baking are improved. It is more preferable to add water to the obtained fat-based confectionery material afterward because neither aggregation nor excessive thickening of the fat-based confectionery material is likely to occur and the effect of improving the shape retaining properties of the fat-based confectionery material during baking is high. With a conventional fat-based confectionery, the meltability in the mouth is degraded when water is added; but in the baked fat-based confectionery according to the embodiment, the interior of the baked fat-based confectionery can keep soft and good meltability in the mouth inherent in fat-based confectionery material even when water is added, due to the effect of the sorbitan fatty acid ester or the specific amount of soy lecithin.

In the embodiment, the amount of water added to the fat-based confectionery material is preferably 0.1 mass % or more and 3 mass % or less, more preferably 0.3 mass % or more and 1 mass % or less relative to the mass of the whole fat-based confectionery material for baking. When the amount of water added is 0.1 mass % or more, the effect of having shape retaining properties of the fat-based confectionery material during baking is obtained sufficiently. When the amount of water is 3 mass % or less, excessive viscosity increase of the fat-based confectionery material is suppressed and workability is kept good, and the effect of the present invention can be obtained sufficiently.

In the embodiment, the fat-based confectionery material may comprise water derived from raw materials other than the added water. For the total amount of water contained in the fat-based confectionery material, it is preferable to be 0.5 to 3.0 mass % relative to the mass of the whole fat-based confectionery material, and it is more preferable to be 0.8 to 2.0 mass %.

### EXAMPLES

Hereinbelow, a description is further given using Examples, but the present invention is not limited to these.

### Manufacturing Example 1

Using 18 parts by mass of cacao mass, 40 parts by mass of sugar, 20 parts by mass of whole milk powder, 21 parts by mass of cocoa butter, 0.5 parts by mass of soy lecithin, and 0.5 parts by mass of flavor, mixing, pulverization, and conching were performed by a conventional method for manufacturing chocolate, and a milk chocolate base material with an oil content of 36 mass % was obtained.

### Example 1

92 parts by mass of the milk chocolate base material obtained in Manufacturing Example 1, 7.5 parts by mass of shortening (trade name: Melano SS, manufactured by Fuji Oil Co., Ltd.), and 0.5 parts by mass of sorbitan trioleate with an HLB of 2.1 (trade name: Emasol O-30 V, manufactured by Kao Chemicals) were mixed, and a fat-based confectionery material for baking A was obtained.

The water content of the obtained fat-based confectionery material for baking A was 1.0 mass % relative to the mass of the whole fat-based confectionery material for baking A.

The obtained fat-based confectionery material for baking A was tempered by a conventional method, and then formed a shape and solidified by cooling; thus, a substantially cubic fat-based confectionery for baking with one side of approximately 1.6 cm and a mass of 4.4 g was obtained.

The obtained fat-based confectionery was baked at 200° C. for 3 minutes in a hot air oven, and a baked fat-based confectionery of Example 1 was obtained. The water content of the obtained fat-based confectionery for baking was 1.0 mass % relative to the mass of the whole fat-based confectionery for baking.

The surface of the obtained baked fat-based confectionery had been solidified by the baking, did not stick to the hand, and had heat resistance, and the interior had soft and good meltability in the mouth inherent in fat-based confectionery and had good quality.

### Test Example 1

Baked fat-based confectioneries comprising emulsifiers were obtained by the same method as in Example 1 except for the type of the emulsifier added (Examples 2 to 4 and Comparative Examples 1 to 9). The obtained baked fat-based confectioneries were subjected to an organoleptic test similarly to Example 1. The results are shown in Table 1.

TABLE 1

| | | | | | Meltability |
|---|---|---|---|---|---|
| | Type | Trade name | Maker | HLB | in mouth |
| Comparative | (No emulsifier added) | — | — | — | D |
| Example 1 | | | | | |
| Comparative | Sucrose fatty acid | ER-290 | Mitsubishi-Shoji | 2.0 | C |
| Example 2 | ester | | Foodtech Co., | | |
| | | | Ltd. | | |
| Comparative | Erucic acid ester | NE-750 | Sakamoto | 3.2 | D |
| Example 3 | | | Yakuhin Kogyo | | |
| | | | Co., Ltd. | | |
| Comparative | Glycerin fatty acid | OE-750 | Sakamoto | 3.7 | D |
| Example 4 | ester | | Yakuhin Kogyo | | |
| | | | Co., Ltd. | | |
| Comparative | Oleic acid ester | PO-5S | Sakamoto | 4.9 | D |
| Example 5 | | | Yakuhin Kogyo | | |
| | | | Co., Ltd. | | |
| Comparative | Stearic acid ester | MO-5S | Sakamoto | 11.6 | D |
| Example 6 | | | Yakuhin Kogyo | | |
| | | | Co., Ltd. | | |
| Comparative | Laurie acid ester | ML-750 | Sakamoto | 14.8 | C-D |
| Example 7 | | | Yakuhin Kogyo | | |
| | | | Co., Ltd. | | |
| Comparative | Polyglycerin ester | THL-15 | Sakamoto | — | C |
| Example 8 | | | Yakuhin Kogyo | | |
| | | | Co., Ltd. | | |
| Comparative | Polyglycerin ester | CRS-75 | Sakamoto | — | D |
| Example 9 | | | Yakuhin Kogyo | | |
| | | | Co., Ltd. | | |
| Example 1 | Sorbitan trioleate | Emasol O-30V | Kao Chemicals | 2.1 | A |
| Example 2 | Sorbitan monolaurate | Emasol L-120V | Kao Chemicals | 15.0 | C |
| Example 3 | Sorbitan monooleate | Emasol O-10V | Kao Chemicals | 4.3 | B |
| Example 4 | Soy lecithin | Nissin Lecithin | The Nissin | 4.0 | B |
| | | DX | OilliO Group | | |
| | | | Ltd. | | |

A: good meltability in the mouth
B: slightly good meltability in the mouth
C: less good meltability in the mouth
D: dry and crumbly, and much less good meltability in the mouth

In the baked fat-based confectionery in which a sucrose fatty acid ester, a lauric acid ester, a polyglyceric acid ester, or a sorbitan fatty acid ester was added, the meltability in the mouth was improved as compared to the baked fat-based confectionery in which nothing was added. Of these, particularly those in which a sorbitan fatty acid ester with an HLB of 5 or less was added had good meltability in the mouth, and that in which a sorbitan fatty acid ester with an HLB of 3 or less was added had better meltability in the mouth. Also the baked fat-based confectionery in which soy lecithin was further added to the chocolate material of the base had good meltability in the mouth.

### Example 5

The milk chocolate base material not comprising sorbitan fatty acid ester and comprising 0.5 parts by weight of soy lecithin obtained in Manufacturing Example 1 was tempered, and then 2.2 g thereof was charged into a substantially cubic mold made of resin with an internal volume of 3.7 ml. Next, the chocolate base material was spread out by force with a mold core made of metal cooled at −20° C. so as to be spread over the entire inner wall in the mold. The mold core made of metal was pulled out, and a cup-shaped fat-based confectionery made of the milk chocolate base material was obtained in the mold.

The fat-based confectionery material for baking A used in Example 1 was tempered, and 1.6 g thereof was charged into the recess of the cup-shaped fat-based confectionery.

From its upper side, 1.0 g of the tempered milk chocolate base material obtained in Manufacturing Example 1 was charged into the cup-shaped fat-based confectionery so as to cover the fat-based confectionery material for baking A that had been charged in the recess. The surplus chocolate material was removed using a scraper so that the upper surface of the charged chocolate material is at the same height as the mold, cooling and solidification were performed, and then the mold was separated; thus, a composite fat-based confectionery for baking X composed of a shell portion made of the milk chocolate base material and a center portion made of the fat-based confectionery material for baking A was obtained.

The mass of the obtained composite fat-based confectionery for baking X was 4.39 g.

The obtained composite fat-based confectionery for baking X was baked at 220° C. for 3 minutes, and a baked composite fat-based confectionery X′ (Example 5) was obtained. The temperature of the central portion of the baked composite fat-based confectionery X′ immediately after the finish of baking was 140° C.

### Comparative Example 10

A composite fat-based confectionery for baking Y and a baked composite fat-based confectionery Y′ (Comparative Example 10) were obtained by the same method as in Example 5 except that a sorbitan fatty acid ester with an HLB of 2.1 was not contained in the fat-based confectionery material for baking used.

### Test Example 2

The hardnesses of the composite fat-based confectioneries for baking X and Y and the baked composite fat-based confectioneries X′ and Y′ obtained were measured. As the measurement method, the maximum stresses when a circular columnar plunger with a diameter of 2 mm was thrust into the baked composite fat-based confectionery with an entry speed of 2 mm/second and an entry length of 4 mm were compared. The temperature of the product during measurement was 20° C. The measurement results are shown in Table 2.

TABLE 2

| | | Hardness | Meltability |
|---|---|---|---|
| Sample | Baking | (gram-weight) | in mouth |
| X | Not performed | 21 | — |
| Y | Not performed | 19 | — |
| X′ (Example 5) | Performed | 99 | A |
| Y′ (Comparative | Performed | 546 | D |
| Example 10) | | | |

In both X′ and Y′, the shell portion had been baked sufficiently, did not stick to the hand, had heat resistance, and had a good crunchy texture. The baked composite fat-based confectionery Y′ in which neither a sorbitan fatty acid ester nor additional soy lecithin was added to the center portion had become excessively hard as compared to before baking, and the center portion was dry, crumbly, and much less good in meltability in the mouth and was unfavorable. On the other hand, in the baked composite fat-based confectionery X′ in which a sorbitan fatty acid ester was added to the center portion, its center portion kept good meltability in the mouth inherent in chocolate and had good quality.

### Manufacturing Example 2

Using 31 parts by mass of lactose, 25 parts by mass of whole milk powder, 10 parts by mass of sugar, 33 parts by mass of shortening (trade name: Melano SS, manufactured by Fuji Oil Co., Ltd.), and 0.5 parts by mass of soy lecithin, mixing, pulverization, and conching were performed by a conventional method for manufacturing chocolate, and a fat-based cream base material with an oil content of 36 mass % was obtained.

### Example 6

74 parts by mass of the fat-based cream base material obtained in Manufacturing Example 2, 16 parts by mass of shortening (trade name: Melano SS, manufactured by Fuji Oil Co., Ltd.), 3 parts by mass of a seeding agent (trade name: BOB Star, manufactured by Fuji Oil Co., Ltd.), 5 parts by mass of cocoa powder, 1 part by mass of soy lecithin, 0.6 parts by mass of water, and 0.5 parts by mass of sorbitan trioleate with an HLB of 2.1 (trade name: Emasol O-30 V, manufactured by Kao Chemicals) were mixed, and a fat-based confectionery material for baking B was obtained.

The water content of the obtained fat-based confectionery material for baking B was 1.5 mass % relative to the mass of the whole fat-based confectionery material for baking B.

The obtained fat-based confectionery material for baking B was formed a shape and solidified by cooling, and a substantially cubic fat-based confectionery for baking with one side of approximately 1.6 cm and a mass of 4.4 g was obtained.

The obtained fat-based confectionery was baked at 200° C. for 3 minutes with a hot air oven, and a baked fat-based confectionery of Example 6 was obtained. The water content of the obtained fat-based confectionery for baking was 1.5 mass % relative to the mass of the whole fat-based confectionery for baking.

The baked fat-based confectionery obtained in Example 6 had a good shape with no deformation due to heating. The surface of the obtained baked fat-based confectionery had been solidified by the baking, did not stick to the hand, and had heat resistance, and the interior had soft and particularly good meltability in the mouth inherent in fat-based confectionery and had particularly good quality.

### Test Example 3

Baked fat-based confectioneries comprising emulsifiers were obtained by the same method as in Example 6 except that the addition amounts of soy lecithin, sorbitan trioleate with an HLB of 2.1, and water were set as shown in Table 3 (Examples 7 to 9). The obtained baked fat-based confectioneries were subjected to an organoleptic test similarly to Example 1. The results are shown in Table 3. The amount of soy lecithin added shown in Table 3 is the amount that is further added separately from the soy lecithin contained in the fat-based cream base material obtained in Manufacturing Example 2. The unit of the numerical value in Table 3 is parts by mass.

TABLE 3

| | | Sorbitan | | |
|---|---|---|---|---|
| | Soy | trioleate | | Meltability |
| | lecithin | (HLB2.1) | Water | in mouth |
| Example 7 | 1 | 0.5 | 0.4 | A+ |
| Example 8 | 1 | 0.2 | 0.4 | A |
| Example 9 | 0.5 | 0.5 | 0.4 | A |
| Example 10 | 0.5 | 0.2 | 0.4 | B |

A+: particularly good meltability in the mouth
A: good meltability in the mouth
B: slightly good meltability in the mouth
C: less good meltability in the mouth
D: dry and crumbly, and much less good meltability in the mouth

The baked fat-based confectioneries obtained in Examples 7 to 10 had a good shape with no deformation due to heating. The surface of the obtained baked fat-based confectioneries had been solidified by the baking, did not stick to the hand, and had heat resistance, and the interior had soft and good meltability in the mouth inherent in fat-based confectionery and had good quality. A baked fat-based confectionery with a larger amount of soy lecithin and/or the sorbitan fatty acid ester added had better meltability in the mouth, and the baked fat-based confectionery with an amount of added additional soy lecithin of 1 part by mass and an amount of the added sorbitan fatty acid ester of 0.5 parts by mass had particularly good meltability in the mouth and had particularly good quality.

1. A baked fat-based confectionery obtained by using a fat-based confectionery material,
wherein the fat-based confectionery material comprises (1) sorbitan fatty acid ester or (2) 0.9 mass % or more of soy lecithin relative to the whole fat-based confectionery material.

2. The baked fat-based confectionery according to claim 1, wherein an HLB of the sorbitan fatty acid ester is 1 or more and 5 or less.

3. The baked fat-based confectionery according to claim 2, wherein the sorbitan fatty acid ester is sorbitan monooleate or sorbitan trioleate.

4. The baked fat-based confectionery according to claim 1, wherein an HLB of the sorbitan fatty acid ester is 1 or more and 3 or less.

5. (canceled)

6. A baked composite fat-based confectionery consisting of a center portion and a shell portion,
wherein the center portion consists of a fat-based confectionery obtained by using a fat-based confectionery material comprising (1) a sorbitan fatty acid ester or (2) 0.9 mass % or more of soy lecithin relative to the whole fat-based confectionery material; and
the shell portion consists of a fat-based confectionery obtained by using a fat-based confectionery material not comprising sorbitan fatty acid ester or 0.9 mass % or more of soy lecithin relative to the whole fat-based confectionery material of the shell portion.

7. (canceled)

8. A method for manufacturing a baked fat-based confectionery, comprising:
a step of preparing a fat-based confectionery material comprising (1) a sorbitan fatty acid ester or (2) 0.9 mass % or more of soy lecithin relative to the whole fat-based confectionery material;
a step of forming the fat-based confectionery material into a prescribed shape to obtain a fat-based confectionery; and
a step of baking the fat-based confectionery.

9. The method for manufacturing a baked fat-based confectionery according to claim 8, wherein an HLB of the sorbitan fatty acid ester is 1 or more and 5 or less.

10. The method for manufacturing a baked fat-based confectionery according to claim 9, wherein the sorbitan fatty acid ester is sorbitan monooleate or sorbitan trioleate.

11. The method for manufacturing a baked fat-based confectionery according to claim 8, wherein an HLB of the sorbitan fatty acid ester is 1 or more and 3 or less.

12. (canceled)

13. The method for manufacturing a baked fat-based confectionery according to claim 8, wherein the fat-based confectionery material contains water.
